(19) United States
(12) Patent Application Publication
(10) Pub. No.: US 2023/0145924 A1
(43) Pub. Date: May 11, 2023

(54) SYSTEM AND METHOD FOR DETECTING A FRAUDULENT ACTIVITY ON A DIGITAL PLATFORM

(71) Applicant: FLIPKART INTERNET PRIVATE LIMITED, Bengaluru (IN)

(72) Inventors: Ankit Vijay, Bangalore (IN); Mahesh Kumar B G, Bangalore (IN)

(73) Assignee: FLIPKART INTERNET PRIVATE LIMITED, Bengaluru (IN)

(21) Appl. No.: 17/979,842

(22) Filed: Nov. 3, 2022

(30) Foreign Application Priority Data
Nov. 5, 2021 (IN) 202141050776

(51) Int. Cl. G06Q 20/40

(52) U.S. Cl. CPC G06Q 20/4016

(57) ABSTRACT

A system and method for detecting a fraudulent activity on a digital platform for a current event. The method encompasses receiving, sequence(s) based on an occurrence of the current event. Each sequence comprises time-ordered event(s). Each time-ordered event comprises attribute(s). Further, the method encompasses determining, an occurrence signature for attribute(s) of each sequence. The method thereafter comprises determining, an interim fraud score and/or an interim latent representation of each sequence based at least on the occurrence signature for attribute(s) in the corresponding sequence, one or more attributes in the corresponding sequence, and one or more positional attributes in the corresponding sequence. The method for detecting the fraudulent activity on the digital platform thereafter comprises generating, a fraud score of the current event based at least on: at least one of the interim fraud score and the interim latent representation, and domain specific feature(s) associated with the current event.

### RELATED APPLICATION

This application claims priority under 35 U.S.C. § 119 to Indian Patent Application No. 202141050776, filed on Nov. 5, 2021, the entire contents of which are incorporated herein by reference.

### TECHNICAL FIELD

The present invention generally relates to data analysis and more particularly to systems and methods for detecting a fraudulent activity on a digital platform for a current event.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Now-a-days, users of electronic devices are provided with a number of facilities. For instance, the users can access various digital platforms over the electronic devices (such as smartphones) to avail various services online. However, a risk of fraudulent activities is always associated with such digital platforms. For instance, a digital platform such as an e-commerce platform provides the users facilities to purchase or sell various products online. However, there is always a risk of fraudulent activities such as including but not limited to payment related frauds, products related frauds and the like over such e-commerce platform. For instance, online payment instruments such as credit/debit cards have become a ubiquitous mode of electronic payment over the past few years. There is an increase in customer adoption towards usage of these payment methods while transacting on the digital platforms (such as the e-commerce platforms). A downside of this growth is the increased opportunity for online fraud. Online payment is one of the prime target for fraudsters as they don't need to physically present the credit/debit card and just need the credit/debit card details which can be stored digitally. Fraudulent transactions only consist of a tiny fraction of the overall traffic volume, leading to huge class imbalance. Further, fraud patterns are anomalous, hard to predict and keep evolving. Therefore, it is important to identify and mitigate such fraudulent activities on the digital platforms.

In order to deal with the fraudulent activities on the digital platforms, a number of solutions have been developed over a period to time. One of such solution is related to a method of detecting fraudulent transactions using a predictive model such as a neural network. This solution also considers past user data to derive variables such as mean dollars of transactions in a month, maximum monthly balance, etc. Also, a system implemented to perform the steps of said method periodically monitors its performance and redevelops the model when performance drops below a predetermined level. Also, one other currently known solution proposes a framework for transaction aggregation and evaluates its effectiveness against non-aggregated features, using a variety of classification methods. Basis such currently known solution, transaction aggregation is found to be effective in predicting fraud and it is observed that the length of the aggregation period has a large impact upon performance. There are a number of limitations of such currently known solutions. For instance, such solutions require explicit creation of hand-crafted aggregation features such as mean dollars of transactions in a month, number of attempted transactions in a day, etc. As these features are explicitly created, they may not be optimal and may not capture all fraud trends. Typically, the features have to be created for multiple time window ranges for different pivots in combination with a specific aggregating function such as mean, max, median, etc. This can lead to feature explosion. Also, such solutions do not utilize the ordering information of events.

Furthermore, some other currently known solutions provide an RNN framework for detecting financial fraud in real time. In such solutions historical payment events over a credit card are captured to form a sequence which is passed as an input to a sequential model to predict fraud. Also, in such solutions categorical features like country code, currency code, or input mode are mapped to embedding which are trained within the model. Such solutions also have various limitations such as a sequence is primarily formed based on a single pivot i.e., card_id, thereby, not capturing linked accounts. These solutions only uses a single event type i.e. payment history. There is no tractable way to represent high cardinality categorical features such as ip_address, device_id, account_id, etc. Further, such solutions cannot represent usage patterns in user action history.

Also, in some other known solutions, RNN based sequence modelling for supervised fraud detection has been proposed. In such solutions different user interactions with a digital platform such as signup, login, logout, payment, etc. are captured to form a sequence which is passed as input to a sequential model to predict fraud. Also, in such solutions categorical features like user-action are mapped to embedding which are trained within the model. These solutions also have limitations such as a sequence formation in such solutions is also primarily based on a single pivot i.e., user_id, thereby, not capturing linked accounts. No practical way to represent high cardinality categorical features such as ip_address, device_id, account_id, etc. are disclosed in such solutions. Also, these currently known solutions cannot represent usage patterns in user action history and only single event type like payment event is used in these solutions. Using a common sequence for heterogeneous data has disadvantages such as coupling of event durations of different event types, padding of non-relevant fields for an event and a longer length sequences which can degrade sequential learning etc.

Therefore, there are a number of limitations of the current solutions and there is a need in the art to provide a method and system for detecting a fraudulent activity on a digital platform.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for detecting a fraudulent activity on a digital platform for a current event. Another object of the present invention is to overcome a need of explicit feature engineering for data aggregation by providing a solution for an automatic aggregation of information for extraction of relevant latent information in a supervised manner, wherein said latent information is capable of capturing information across different time window ranges implicitly. Also, an object of the present invention is to model different events as data sequences to inherently utilize ordering information of events. Another object of the present invention is to provide a solution of formation of a common sequence based on multiple pivots like email, phone, card_id and device_id etc. to do account linking. Another object of the present invention is to provide an occurrence signature in sequential modelling to represent usage patterns in user action history for high cardinality categorical features such as ip_address, device_id, account_id, etc., but the same is not limited thereto and the scope may be extended to low cardinality categorical features as well. Also, an object of the present invention is to support a use of multiple sequence aggregators to feed history of different kinds of user actions as inputs to a training model. Another object of the present invention is to provide a solution that allows to decouple event durations for sequence formation and maintains sequence-specific homogeneous data for learning. Yet another object of the present invention is to provide a solution that leads to shorter length sequences which are preferable for better sequential learning.

Furthermore, in order to achieve the aforementioned objectives, the present invention provides a method and system for detecting a fraudulent activity on a digital platform for a current event.

A first aspect of the present invention relates to the method for detecting a fraudulent activity on a digital platform for a current event. The method comprises identifying, by an identification unit, an occurrence of the current event on the digital platform. The method thereafter encompasses receiving, by a transceiver unit, one or more sequences based on the occurrence of the current event. Each sequence of the one or more sequences comprises of one or more time-ordered events performed on a set of pivots and each sequence of the one or more sequences is associated with a unique event type. Also, each time-ordered event from the one or more time-ordered events comprises one or more attributes. Further, the method encompasses determining, by a processing unit, an occurrence signature for the one or more attributes of each sequence, wherein the occurrence signature is based on the one or more time-ordered events of a corresponding sequence. The method thereafter comprises determining, by a sub-system, at least one of an interim fraud score and an interim latent representation of each sequence, wherein at least one of the interim fraud score and the interim latent representation of each sequence is based at least on the occurrence signature for the one or more attributes in the corresponding sequence, the one or more attributes in the corresponding sequence, and one or more positional attributes in the corresponding sequence. The method thereafter comprises generating, by the processing unit, a fraud score of the current event based at least on: at least one of the interim fraud score and the interim latent representation of each sequence, and one or more domain specific features associated with the current event. Further the method leads to detecting, by the processing unit, the fraudulent activity on the digital platform based on the fraud score of the current event.

Another aspect of the present invention relates to a system for detecting a fraudulent activity on a digital platform for a current event. The system comprises an identification unit, configured to identify, an occurrence of the current event on the digital platform. The system also comprises a transceiver unit, configured to receive, one or more sequences based on the occurrence of the current event, wherein each sequence of the one or more sequences comprises of one or more time-ordered events performed on a set of pivots and each sequence of the one or more sequences is associated with a unique event type, wherein each time-ordered event from the one or more time-ordered events comprises one or more attributes. The system further comprises a processing unit, configured to determine, an occurrence signature for the one or more attributes of each sequence, wherein the occurrence signature is based on the one or more time-ordered events of a corresponding sequence. Also, the system comprises a sub-system, configured to determine, at least one of an interim fraud score and an interim latent representation of each sequence, wherein the at least one of the interim fraud score and the interim latent representation of each sequence is based at least on the occurrence signature for the one or more attributes in the corresponding sequence, the one or more attributes in the corresponding sequence, and one or more positional attributes in the corresponding sequence. Further, the processing unit is configured to generate, a fraud score of the current event based at least on: at least one of the interim fraud score and interim latent representation of each sequence, and one or more domain specific features associated with the current event. Also, the processing unit is further configured to detect, the fraudulent activity on the digital platform based on the fraud score of the current event.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for detecting a fraudulent activity on a digital platform for a current event, in accordance with exemplary embodiments of the present invention.

FIG. 2 illustrates an exemplary method flow diagram [200], for detecting a fraudulent activity on a digital platform for a current event, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from an identification unit, a processing unit, a transceiver unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As used herein, “transceiver unit” may include but not limited to a transmitter to transmit data to one or more destinations and a receiver to receive data from one or more sources. Further, the transceiver unit may include any other similar unit obvious to a person skilled in the art, to implement the features of the present invention. The transceiver unit may convert data or information to signals and vice versa for the purpose of transmitting and receiving, respectively.

As used herein, an “event” refers to a user interaction with a digital platform. The event may be of different types like browse, payment, order, etc. Also, each event consists of one or more attributes which characterize it.

As used herein, a “sequence” is defined as a time-ordered list of one or more events of specific event type.

As used herein, a “pivot” is defined as a dimension for referring to one or more historical events with specific value of an attribute. For example, email_id etc.

As used herein, an “attribute” is a named-entity to refer to a specific property of an event. For instance, “ip_address” attribute of a payment transaction (i.e. an event type) may refer to a user IP address from which a transaction is initiated.

As used herein, an “Entity/User” is identified by a combination of one or more pivots.

As disclosed in the background section, existing technologies have many limitations and in order to overcome at least some of the limitations of the prior known solutions, the present disclosure provides a solution for detecting a fraudulent activity on a digital platform for a current event. More specifically, for detecting the fraudulent activity (such as including but not limited to a suspicious online payment transaction) on the digital platform, the present invention provides automated feature engineering and information extraction from sequential data. The present invention discloses capturing of one or more entity/user interaction patterns over a time frame, multi-dimensional information linking and automatic data aggregation in a supervised manner for predictive modelling. The capturing of the one or more entity/user interaction patterns over the time frame helps in providing a mechanism to combine structured and unstructured user behavior data together and project it in a latent space in a supervised manner to detect fraudulent activities in digital space (such as fraudulent payment transactions in an e-commerce space). In an event the user interaction behavior data may be captured in the form of one or more sequences of different types of events like browse, payment, etc. Further, one or more attributes of an event can be derived from the structured data (i.e., a data in a structured manner) or the unstructured data (i.e., a data in an unstructured manner). Example of structured data may include an amount of a transaction, an order delivery SLA, a saved card, etc. Example of attributes derived from unstructured data may include an incomplete shipping address score (derived from order shipping address) and an email username monkey-typed score (derived from email of the user) etc. Furthermore, in order to capture usage interaction patterns associated with various attributes (like ip-address, email, phone, card_id, device_id) in a user action sequence (common sequence), the present invention provides a novel method to represent such patterns using occurrence signatures which also allows to link actions within the sequence (i.e. the user action sequence) based on multiple attributes. An occurrence signature captures attribute-interplay in an elegant manner and can easily scale for a large number of attributes within a sequence. The formation of the common sequence based on multiple pivots like email, phone, card_id and device_id helps in linking behavior across users and generating enriched user behavior history. A user may be identified based on a combination of one or more pivots associated with an ongoing event such as an ongoing payment transaction.

Furthermore, the present invention also encompasses incorporating different sources of user action behavior like browse history, payment history, order history, login history, etc., as individual sequences. In an implementation these individual sequences may be truncated, wherein such truncated sequences of actions may be provided for a model training which can improve early detection of fraud or said truncated sequences may also be used for data augmentation during training of the model. The present invention also encompasses use of one or more domain specific features for detecting the fraudulent activity, wherein the one or more domain specific features may include at least one of: model based features such as custom developed ML models for getting specific insight (like email genuineness, incomplete address, anomaly score etc.), that may be used as predictors in a downstream model; and derived features that include features which are typically arrived by developing domain specific intelligence over raw data such as data transformation (for instance: IP intelligence, target feedback, address linking etc.). More specifically, for detecting the fraudulent activity, the one or more domain specific features may be combined with the latent representations of the aggregated sequences.

The solution as disclosed in the present invention effectively aggregates a user action behavior over a span of time duration in a supervised manner using sequential modelling. Apart from automated fraud detection, the present solution can be applied in various other applications which rely on temporal entity/user behavior insights for making predictions.

Therefore, the present invention provides a novel solution of detecting the fraudulent activity on the digital platform for the current event. The present invention provides a technical advancement over the currently known solutions by capturing usage patterns of different attributes (like device_id, ip_address, account_id etc.) in a user action history using occurrence signatures for detecting the fraudulent activity on the digital platform. Also, the present invention provides a technical advancement over the currently known solutions by enabling multi-dimensional information linking by formation of a common sequence based on multiple pivots like email, phone, card_id and device_id etc. to do account linking. Also, the present invention provides a technical advancement over the currently known solutions by using multiple sequence aggregators to feed history of different kinds of user actions as inputs to a ML model. The automated feature learning as disclosed in the present invention reduces feature engineering efforts. Also, the sequence truncation as disclosed in the present invention helps in early fraud detection and data augmentation.

Hereinafter, exemplary embodiments of the present disclosure will be described in detail with reference to the accompanying drawings so that those skilled in the art can easily carry out the present disclosure.

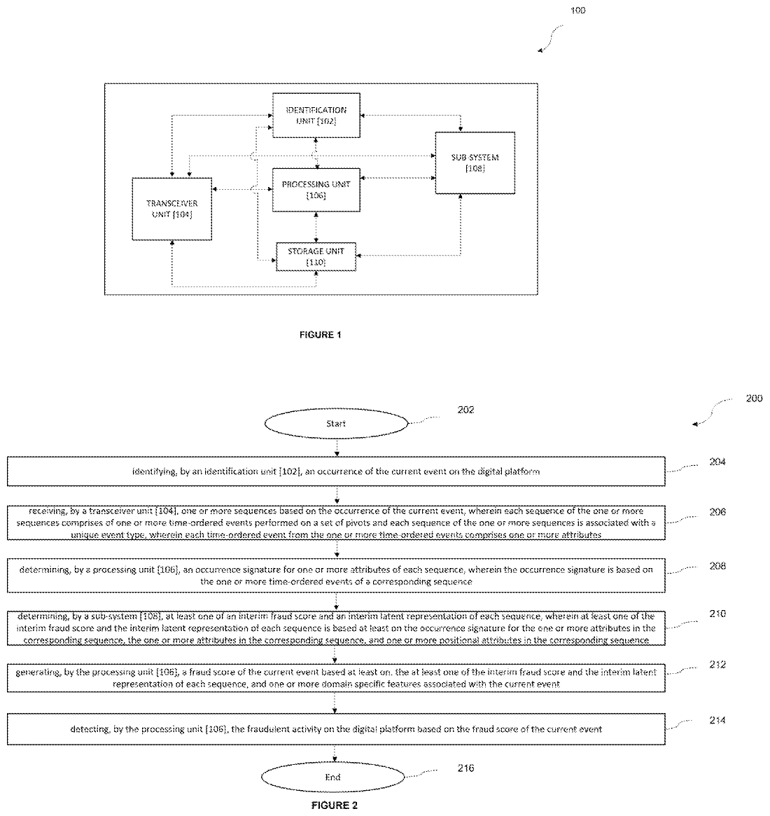

Referring to FIG. 1, an exemplary block diagram of a system [100] for detecting a fraudulent activity on a digital platform for a current event is shown. In an implementation the system [100] may be connected to a server unit and in another implementation the system [100] may resides within the server unit to implement the features of the present disclosure. The system [100] comprises at least one identification unit [102], at least one transceiver unit [104], at least one processing unit [106], at least one sub-system [108] and at least one storage unit [110]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of the units, as required to implement the features of the present disclosure.

The system [100] is configured to detect a fraudulent activity on a digital platform for a current event, with the help of the interconnection between the components/units of the system [100].

The identification unit [102] of the system [100] is connected to the at least one transceiver unit [104], the at least one processing unit [106], the at least one sub-system [108] and the at least one storage unit [110]. The identification unit [102] is configured to identify, an occurrence of the current event on the digital platform. In a preferred implementation the digital platform is an e-commerce platform and the current event is a current user interaction with the e-commerce platform. For instance, the current event may include but not limited to a current browse event, a current payment event, a current order placement event, etc. Also, the current event is associated with one or more current attributes. For instance, a current payment event may be associated with an email, a phone number, a bank identifier, an amount and/or the like attribute(s) which characterize it.

Once the occurrence of the current event is identified on the digital platform, an indication of the same is provided to the transceiver unit [104] by the identification unit [102]. The transceiver unit [104] is then configured to receive, one or more sequences based on the occurrence of the current event. Each sequence of the one or more sequences comprises of one or more time-ordered events performed on a set of pivots and each sequence of the one or more sequences is associated with a unique event type. For example, if a unique event type is a browse event, a sequence associated with said browse event comprises one or more time-ordered events such as a first browse event, a second browse event and a third browse event that are ordered based on an associated time stamp. Also, each of the first browse event, the second browse event and the third browse event are performed on one or more pivots such as an e-mail ID, an IP address etc. Furthermore, each sequence of the one or more sequences is generated by the processing unit [106]. More specifically, the processing unit [106] is configured to generate each sequence of the one or more sequences based on an identification of: one or more past events associated with the one or more current attributes, and the one or more time-ordered events based on removal of one or more duplicate past events. For example, if a current event is a payment event and said current payment event is associated with a current email ID and a current IP address (i.e. current attributes). The processing unit [106] in the given example is configured to generate a sequence of one or more time-ordered events based on: an identification of one or more past events (say past payment events or such other events) associated with the current email ID and the current IP address by the identification unit [102], and an identification of said one or more time-ordered events by the identification unit [102] based on removal of one or more duplicate past payment events. For instance, if 10 past payment events associated with the current email ID and the current IP address are identified, a sequence may be generated by firstly sorting all the 10 past payment events in a list based on an associated time stamp and then by removing any duplicate past payment events from this list to keep only one copy of each past event. Therefore, in the given instance the generated sequence comprises one or more non-repeating time-ordered past payment events.

Also, each sequence of the one or more time-ordered events is associated with a specific time duration. More particularly, while generating said each sequence, the one or more past events associated with the one or more current attributes are identified for the specific time duration, therefore said each sequence is also associated with said specific time duration. For instance, if one or more past events associated with one or more current attributes are identified for past 14 days, a generated sequence in such instance is also associated with the 14 days' time period. Furthermore, each time-ordered event from the one or more time-ordered events comprises one or more attributes. The one or more attributes comprises at least one of one or more numerical attributes and one or more categorical attributes. An attribute may be referred as a numerical attribute if it indicates a mathematical property of an event (such as an amount, a number of products ordered etc.) and an attribute may be referred as a categorical attribute if it indicates a non-mathematical property of an event (such as an email ID, a type of ordered product etc.).

Also, in an implementation, the one or more time-ordered events may be truncated based on one or more predefined rules. The one or more predefined rules may include but not limited to a selection of one or more latest time-ordered events, a selection of one or more time-ordered events between a specific time period and the like. For instance, a sequence comprising of n time-ordered events may be truncated to keep only latest k time-ordered events but the same is not limited thereto and said truncation may vary based on different use cases and/or implementations.

Thereafter, to capture user action pattern(s) within each sequence (or in an event in each truncated sequence), the processing unit [106] is configured to determine, an occurrence signature for the one or more attributes of each sequence, wherein the occurrence signature is based on the one or more time-ordered events of a corresponding sequence. An occurrence signature of an attribute for a sequence of one or more time-ordered events is defined as a signature/list of a unique identifier assigned to an observed attribute value corresponding to the one or more attributes in said sequence. More specifically, to determine the occurrence signature for the one or more attributes of each sequence, the processing unit [106] is firstly configured to assign, a unique ordinal identifier to a value of the one or more attributes. Thereafter, the processing unit [106] is configured to determine, the occurrence signature of the one or more attributes based on the assigned unique ordinal identifier of the value of the one or more attributes. For instance, in an implementation to determine an occurrence signature for a categorical and/or numerical attribute present in a sequence, the processing unit [106] starting from an oldest event in said sequence is firstly configured to assign a unique ordinal identifier to one or more unique attribute values. Thereafter, in an event, at later steps of said sequence, if an attribute value similar to said unique attribute value is identified, the processing unit [106] is then configured to assign to it, a corresponding identifier (i.e. the unique ordinal identifier that is already assigned to similar attribute value). Also, in an event, at later steps of said sequence, if an attribute value is identified that is not similar to the unique attribute value, the processing unit [106] is then configured to assign to it, a next unique ordinal identifier. For example: If a sequence of payment events on four different pivots (i.e., email_id=‘email1’, phone_num=‘phone1’, device_id′=‘d1’ and ip_address=‘ip1’) is as follows:

1. eₚ₁(email_id=‘email1’, phone_num=‘phone1’, device_id′=‘d1’, ip_address=‘ip1’)

2. eₚ₂(email_id=‘email1’, phone_num=‘phone2’, device_id′=‘d1’, ip_address=‘ip1’)

3. eₚ₃(email_id=‘email2’, phone_num=‘phone2’, device_id′=‘d1’, ip_address=‘ip2’)

4. eₚ₄(email_id=‘email1’, phone_num=‘phone1, device_id’=‘d1’, ip_address=‘ip3’)

5. eₚ₅(email_id=‘email1’, phone_num=‘phone1, device_id’=‘d1’, ip_address=‘ip4’)

where, eₚ₁-eₚ₅ are payment events. In the given example, occurrence signatures are as follows (using numbers starting from 1 as identifiers):

| Categorical Attribute | Occurrence Signature |
|---|---|
| Email_id | [1, 1, 2, 1, 1] |
| phone_num | [1, 2, 2, 1, 1] |
| device_id | [1, 1, 1, 1, 1] |
| ip_address | [1, 1, 2, 3, 4] |

The occurrence signature as disclosed in the present invention provides a technical advancement over the currently known solutions as the conventional solutions to represent categorical features assign a unique identifier to each value of a categorical attribute based on a complete dataset. However in the present invention sequence specific identifiers (i.e. occurrence signatures) are generated. Also, the occurrence signature as disclosed in the present invention provides a technical advancement over the currently known solutions by allowing representation of high cardinality categorical attributes conveniently. For instance, email_id, card_id, device_id, phone_number, ip_address, etc. Also, some attributes like ip_address, having a global semantic representation may not make sense as ip_addresses are volatile. In such cases, the occurrence signatures enable capturing of a pattern in a sequence and therefore provide another technical advancement over the currently known solutions. The occurrence signatures also provide a capability to form a sequence-local semantic representation of an attribute. For instance, if there is a sequence of 5 time-ordered events as e_1, e_2, e_3, e_4 and e_5, for an ongoing transaction on some set of pivots based on past 7 days of events data. For said sequence, following are some examples of occurrence signature using attribute as ip_address:

1. All ip_addresses are unique:
I. ip1, ip2, ip3, ip4, ip5→[1,2,3,4,5]

2. Same ip_address in all events
II. ip1, ip1, ip1, ip1, ip1→[1,1,1,1,1]

3. Some pattern
III. ip1, ip2, ip1, ip2, ip1→[1,2,1,2,1]
IV. ip1, ip2, ip3, ip2, ip1→[1,2,3,2,1]

Once, the occurrence signature for the one or more attributes of each sequence is determined, the same is provided to the sub-system [108] along with the one or more attributes of said each sequence and one or more positional attributes of said each sequence, to determine at least one of an interim fraud score and an interim latent representation of each sequence. The sub-system [108] is a model trained based on a data associated with a plurality of sequences such as a plurality of categorical and/or numerical attributes associated with the plurality of sequences, an occurrence signature determined for the one or more attributes associated with the plurality of sequences and a plurality of positional attributes associated with the plurality of sequences. More specifically, the sub-system [108] is configured to determine, the at least one of the interim fraud score and the interim latent representation of each sequence, wherein the interim fraud score and/or the interim latent representation of each sequence is based at least on the occurrence signature for the one or more attributes in the corresponding sequence, one or more attributes in the corresponding sequence, and one or more positional attributes in the corresponding sequence. The one or more positional attributes are determined based on the time stamp associated with the one or more time-ordered events present in the corresponding sequence. Also, in an implementation, the one or more positional attributes are determined at each time step to capture a relative time ordering between time-ordered events of a corresponding sequence. In an instance, in order to determine an interim fraud score and/or an interim latent representation of a sequence say sequence 1, an occurrence signature for the one or more attributes present in said sequence 1, the one or more attributes (i.e. one or more categorical and/or numerical attributes) associated with the sequence 1 and one or more positional attributes associated with the sequence 1 are provided to the sub-system [108] as an input. The sub-system [108] thereafter based on the received input determines the interim fraud score and/or the interim latent representation of the sequence 1, wherein the sub-system [108] is a model trained based on a data associated with a plurality of sequences such as a plurality of categorical and/or numerical attributes associated with the plurality of sequences, an occurrence signature determined for the one or more attributes associated with the plurality of sequences and a plurality of positional attributes associated with the plurality of sequences.

Furthermore, in an implementation, the sub-system [108] may be a supervised sequence aggregator, utilizing LSTM for sequential modelling. For training of such sub-system [108], the one or more attributes associated with the plurality of sequences, an occurrence signature determined for the one or more attributes associated with the plurality of sequences are passed to the sub-system [108] as an input via an embedding layer. Additionally, a plurality of positional attributes associated with the plurality of sequences are also passed as the input for training of said sub-system [108]. The sub-system [108] is trained in a supervised manner (for instance using backpropagation where standard approaches like gradient descent to learn weights of a neural network are followed) based on observed data points. Also, in an implementation, instead of LSTM, other variants of sequential models like GRU, RNN, transformers may also be used as the sub-system [108] to implement the features of the present invention.

Also, in an implementation for training of the sub-system [108], the plurality of sequences may be truncated to capture more local behavior patterns and to improve early detection of the interim fraud. For instance, a truncated sequence of latest k time-ordered events of a sequence of n time-ordered events may be considered while model training. In one other instance, depending on a use case, a data associated with any continuous sub-sequence of time-ordered events of an original sequence may be provided as an input for training of the sub-system [108]. This can also be used as a data augmentation method which also helps in regularizing the sub-system [108].

Further, the processing unit [106] is configured to generate, a fraud score of the current event based at least on: at least one of the interim fraud score and the interim latent representation of each sequence, and one or more domain specific features associated with the current event. In an implementation the one or more domain specific features may include at least one of, one or more raw features, one or more model based features and one or more derived features. In an example a raw feature may be a transaction amount, number of failed transactions is last ‘n’ number days, a number of delivered orders is last ‘n’ number of days, etc. The one or more model based features are determined based on one or more custom developed ML models for getting specific insight whose output is used as predictors in a downstream model. In an event, for payment fraud detection, the one or more custom developed ML models may include ML models such as:

a) Email Genuineness Model: For example using char-RNN based language model for email usernames.
b) Incomplete address Model: For example using supervised learning of incomplete addresses.
c) Anomaly score Model: For example using PCA (Principal Component Analysis) reconstruction error computed on one or more raw aggregation features like number of failed transactions in last ‘n’ days etc.

Also, the one or more derived features may include but not limited to one or more features which are typically arrived by developing domain specific intelligence over raw data such as data transformation. For instance, for payment fraud detection, the derived features may include features such as IP intelligence, target feedback, address linking etc.

In an implementation, to generate the fraud score of the current event, the one or more domain specific features associated with the ongoing/current event may be concatenated with the latent representations of the one or more sequences.

Further, once the fraud score of the current event is generated, the processing unit [106] is thereafter configured to detect, the fraudulent activity on the digital platform based on the fraud score of the current event. For instance, the fraud score of the current event may vary from 0 to 1, where 0 indicates a minimum possibility of detection of an activity as the fraudulent activity on the digital platform and 1 indicates a maximum possibility of detection of an activity as the fraudulent activity on the digital platform. Therefore, based on the fraud score of the current event any activity on the digital platform may be flagged as a fraudulent activity or a genuine activity. Also, in an implementation, if any activity is detected as the fraudulent activity on the digital platform, the same may be barred by the processing unit [106].

Referring to FIG. 2 an exemplary method flow diagram [200], for detecting a fraudulent activity on a digital platform for a current event, in accordance with exemplary embodiments of the present disclosure is shown. In an implementation the method is performed by the system [100]. Further, in an implementation, the system [100] is connected to a server unit and in another implementation the system [100] is placed in the server unit to implement the features of the present disclosure. Also, as shown in FIG. 2, the method starts at step [202].

At step [204] the method comprises identifying, by an identification unit [102], an occurrence of the current event on the digital platform. In a preferred implementation the digital platform is an e-commerce platform and the current event is a current user interaction with the e-commerce platform. For instance, the current event may include but not limited to a current add to cart event, a current product selection event, a current transaction event, etc. Also, the current event is associated with one or more current attributes. For instance, a current payment event may be associated with an email, an IP address, a user identifier, a type of a selected product and/or the like attribute(s) which characterize said current event.

Once the occurrence of the current event is identified on the digital platform, an indication of the same is provided to a transceiver unit [104] by the identification unit [102]. Next, the method at step [206] comprises receiving, by the transceiver unit [104], one or more sequences based on the occurrence of the current event. Each sequence of the one or more sequences comprises of one or more time-ordered events performed on a set of pivots and each sequence of the one or more sequences is associated with a unique event type. For example, if a unique event type is a payment event, a sequence associated with said payment event comprises one or more time-ordered events such as a first payment event, a second payment event and a third payment event that are ordered based on an associated time stamp. Also, each of the first payment event, the second payment event and the third payment event are performed on one or more pivots such as a phone number, a device ID etc. Also, the method comprises generating by a processing unit [106], each sequence of the one or more sequences, based on firstly identifying, by the identification unit [102], one or more past events associated with the one or more current attributes, and then identifying, by the identification unit [102], the one or more time-ordered events based on removal of one or more duplicate past events. For example, if a current event is a browse event and said current browse event is associated with a current email ID and a current IP address (i.e. current attributes). The method in the given example comprises generating by the processing unit [106], a sequence of one or more time-ordered events based on: an identification of one or more past events (say past browse events or such other events) associated with the current email ID and the current IP address, and an identification of said one or more time-ordered events based on removal of one or more duplicate past browse events. For instance, if 15 past browse events associated with the current email ID and the current IP address are identified, the method may comprise generating by the processing unit [106] a sequence by firstly sorting all the 15 past browse events in a list based on an associated time stamp of each browse event and then by removing any duplicate past browse events from this list to keep only one copy of each past browse event. Therefore, in the given instance the generated sequence comprises one or more non-repeating time-ordered past browse events.

Also, each sequence of the one or more time-ordered events is associated with a specific time duration. More particularly, while generating said each sequence, the one or more past events associated with the one or more current attributes may be identified for the specific time duration, therefore said each sequence may also be associated with said specific time duration. For instance, if one or more past events associated with one or more current attributes are identified for past 50 days, a generated sequence in such instance is also associated with the 50 days' time period. Furthermore, each time-ordered event from the one or more time-ordered events comprises one or more attributes. The one or more attributes comprises at least one of one or more numerical attributes and one or more categorical attributes. An attribute may be referred as a numerical attribute if it indicates a mathematical property of an event (such as a payment amount, a number of products selected etc.) and an attribute may be referred as a categorical attribute if it indicates anon-mathematical property of an event (such as a username, a type of selected product etc.).

Also, in an implementation, the method encompasses truncating by the processing unit [106], the one or more time-ordered events, based on one or more predefined rules. The one or more predefined rules may include but not limited to a selection of one or more of latest or oldest time-ordered events, a selection of one or more time-ordered events between a specific time period and the like rules. For instance, a sequence comprising of n time-ordered events may be truncated to keep only first k time-ordered events but the same is not limited thereto and said truncation may vary based on different use cases and/or implementations.

Further, to capture user action pattern(s) within each sequence (or in an event in each truncated sequence), at step [208] the method comprises determining, by the processing unit [106], an occurrence signature for one or more attributes of each sequence, wherein the occurrence signature is based on the one or more time-ordered events of a corresponding sequence. An occurrence signature of an attribute for a sequence of one or more time-ordered events is defined as a signature/list of a unique identifier (or unique ordinal identifier) assigned to an observed attribute value corresponding to the one or more attributes in said sequence. More specifically, the method of determining, by the processing unit [106], an occurrence signature for the one or more attributes of each sequence firstly comprises assigning, by the processing unit [106], a unique ordinal identifier to a value of the one or more attributes. Thereafter, said method leads to determining, by the processing unit [106], the occurrence signature of the one or more attributes based on the assigned unique ordinal identifier of the value of the one or more attributes. For instance, in an implementation to determine an occurrence signature for a categorical and/or numerical attribute present in a sequence, the method firstly encompasses assigning by the processing unit [106] a unique ordinal identifier to the one or more unique attribute values, starting from an oldest event in said sequence. Thereafter, in an event, at later steps of said sequence, if an attribute value similar to said unique attribute value is identified, the method then comprises assigning to it, by the processing unit

, a corresponding identifier (i.e. the unique ordinal identifier that is already assigned to similar attribute value). Also, in an event, at later steps of said sequence, if an attribute value is identified that is not similar to the unique attribute value, the method then comprises assigning to it, by the processing unit [106], a next unique ordinal identifier. For example: If a sequence of purchase events on three different pivots (i.e., email_id=‘email1’, device_id’=‘d1’ and ip_address=‘ip1’) is as follows:

1. eₚ₁(email_id=‘email1’, device_id′=‘d1’, ip_address=‘ip1’)

2. eₚ₂(email_id=‘email2’, device_id′=‘d2’, ip_address=‘ip1’)

3. eₚ₃(email_id=‘email2’, device_id′=‘d3’, ip_address=‘ip1’)

4. eₚ₄(email_id=‘email2’, device_id′=‘d4’, ip_address=‘ip1’)

5. eₚ₅(email_id=‘email1’, device_id′=‘d5’, ip_address=‘ip1’)

where, eₚ₁-eₚ₅ are purchase events. In the given example, occurrence signatures are as follows (using numbers starting from 1 as identifiers):

| Categorical Attribute | Occurrence Signature |
|---|---|
| Email_id | [1, 2, 2, 2, 1] |
| device_id | [1, 2, 3, 4, 5] |
| ip_address | [1, 1, 1, 1, 1] |

As already disclosed above under the description of FIG. 1, the occurrence signature as disclosed in the present invention provides a number of technical advancement over the currently known solutions.

Once, the occurrence signature for the one or more attributes of each sequence is determined, the same is provided to a sub-system [108] along with the one or more attributes of said each sequence and one or more positional attributes of said each sequence, to determine at least one of an interim fraud score and an interim latent representation of each sequence. The sub-system [108] is a model trained based on a data associated with a plurality of sequences such as a plurality of categorical and/or numerical attributes associated with the plurality of sequences, an occurrence signature determined for the one or more attributes associated with the plurality of sequences and a plurality of positional attributes associated with the plurality of sequences. Further, at step [210], the method comprises determining, by the sub-system

, at least one of the interim fraud score and the interim latent representation of each sequence, wherein the interim fraud score and/or the interim latent representation of each sequence is based at least on the occurrence signature for the one or more attributes in the corresponding sequence, one or more attributes in the corresponding sequence, and one or more positional attributes in the corresponding sequence. The one or more positional attributes are determined based on the time stamp associated with the one or more time-ordered events present in the corresponding sequence. Also, in an implementation, the one or more positional attributes are determined at each time step to capture a relative time ordering between time-ordered events of a corresponding sequence. In an instance, in order to determine an interim fraud score and/or an interim latent representation of a sequence say sequence A, an occurrence signature for the one or more attributes present in said sequence A, the one or more attributes (i.e. one or more categorical and/or numerical attributes) associated with the sequence A and one or more positional attributes associated with the sequence A are provided to the sub-system [108] as an input. The method thereafter encompasses, determining by the sub-system [108], the interim fraud score and/or the interim latent representation of the sequence A based on the received input, wherein the sub-system [108] is a model trained based on a data associated with a plurality of sequences such as a plurality of categorical and/or numerical attributes associated with the plurality of sequences, an occurrence signature determined for the one or more attributes associated with the plurality of sequences and a plurality of positional attributes associated with the plurality of sequences.

Furthermore, in an implementation, the sub-system [108] may be a supervised sequence aggregator, utilizing LSTM for sequential modelling. For training of such sub-system [108], one or more attributes associated with the plurality of sequences, an occurrence signature determined for the one or more attributes associated with the plurality of sequences are passed to the sub-system [108] as an input via an embedding layer. Additionally, a plurality of positional attributes associated with the plurality of sequences are also passed as the input for training of said sub-system [108]. The sub-system [108] is trained in a supervised manner. Also, in an implementation, instead of LSTM, other variants of sequential models like GRU, RNN, transformers may also be used as the sub-system [108] to implement the features of the present invention.

Next, at step [212] the method comprises generating, by the processing unit [106], a fraud score of the current event based at least on: at least one of the interim fraud score and the interim latent representation of each sequence, and one or more domain specific features associated with the current event. In an implementation the one or more domain specific features may include at least one of, one or more raw features, one or more model based features and one or more derived features. In an example a raw feature may be a transaction amount, number of failed transactions is last ‘n’ number days, a number of delivered orders is last ‘n’ number of days, etc. The one or more model based features are determined based on one or more custom developed ML models for getting specific insight whose output is used as predictors in a downstream model. Also, the one or more derived features may include but not limited to one or more features which are typically arrived by developing domain specific intelligence over raw data such as data transformation. For instance, for payment fraud detection, the derived features may include features such as IP intelligence, target feedback, address linking etc.

Further, once the fraud score of the current event is generated, next, at step [214] the method comprises detecting, by the processing unit [106], the fraudulent activity on the digital platform based on the fraud score of the current event. For instance, the fraud score of the current event may vary from 1 to 10, where 1 indicates a minimum possibility of detection of an activity as the fraudulent activity on the digital platform and 10 indicates a maximum possibility of detection of an activity as the fraudulent activity on the digital platform. Therefore, based on the fraud score of the current event any activity on the digital platform may be flagged as a fraudulent activity or a genuine activity. Also, in an implementation, if any activity is detected as the fraudulent activity on the digital platform, the same may be barred by the processing unit [106].

After detecting the fraudulent activity on the digital platform for the current event, the method terminates at step [216].

The present invention therefore provides a solution that automatically extracts relevant information from multiple event types for predictive modelling by introducing a dedicated sequence aggregator for each individual sequence into an ML model. Further, as compared to the currently known solutions related to a common single sequence consisting of heterogeneous event types for fraud detection, the present solution has following technical advantages:
1) The present solution allows to decouple event durations for sequence formation, for example, for browse-data last 7 days history may be utilized and for payments-data last 90 days history may be utilized.
2) The present solution maintains sequence-specific homogeneous data (i.e. event type) for learning and does not require padding of non-applicable attributes for an event.
3) As compared to a large common sequence of various events, having separate sequence for each kind of event divides the events into multiple sequence aggregators, thereby reducing a sequence length. The present solution discloses use of such shorter length sequences which are preferable for better sequential learning as:
   a. Typically, sequence models have a limit on maximum sequence length (due to vanishing and exploding gradients problem). 250-500 time steps is often used in practice as the maximum sequence length size.

Use Cases: Although there are a number of use cases of the present invention, but some are listed as below:
Automatic feature engineering from temporal data.
As almost all kinds of user-actions can be automatically aggregated based on the implementation of the features of the present invention, the present solution significantly reduces the need to do feature engineering for every new model release. A model can just be retrained with recent data.
The present solution may be used in predictive modelling for various e-commerce applications such as:
   Payment fraud detection
   Financial/Lending fraud detection
   Customer churn prediction
   Reseller fraud detection

Thus, the present invention provides a novel solution of detecting the fraudulent activity on the digital platform for the current event. The present invention provides a technical advancement over the currently known solutions by capturing usage patterns of different attributes (like device_id, ip_address, account_id etc.) in a user action history using occurrence signatures for detecting the fraudulent activity on the digital platform. Also, the present invention provides a technical advancement over the currently known solutions by enabling multi-dimensional information linking by formation of a common sequence based on multiple pivots like email, phone, card_id and device_id etc. to do account linking. Also, the present invention provides a technical advancement over the currently known solutions by using multiple sequence aggregators to feed history of different kinds of user actions as inputs to a ML model. The automated feature learning as disclosed in the present invention reduces feature engineering efforts. Also, the sequence truncation as disclosed in the present invention helps in early fraud detection and data augmentation.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A method for detecting a fraudulent activity on a digital platform for a current event, the method comprising:
identifying, by an identification unit [102], an occurrence of the current event on the digital platform;
receiving, by a transceiver unit [104], one or more sequences based on the occurrence of the current event, wherein each sequence of the one or more sequences comprises of one or more time-ordered events performed on a set of pivots and each sequence of the one or more sequences is associated with a unique event type, wherein each time-ordered event from the one or more time-ordered events comprises one or more attributes;
determining, by a processing unit [106], an occurrence signature for one or more attributes of each sequence, wherein the occurrence signature is based on the one or more time-ordered events of a corresponding sequence;
determining, by a sub-system [108], at least one of an interim fraud score and an interim latent representation of each sequence, wherein at least one of the interim fraud score and the interim latent representation of each sequence is based at least on the occurrence signature for the one or more attributes in the corresponding sequence, the one or more attributes in the corresponding sequence, and one or more positional attributes in the corresponding sequence;
generating, by the processing unit [106], a fraud score of the current event based at least on: the at least one of the interim fraud score and the interim latent representation of each sequence, and one or more domain specific features associated with the current event; and
detecting, by the processing unit [106], the fraudulent activity on the digital platform based on the fraud score of the current event.

2. The method as claimed in claim 1, wherein the current event is associated with one or more current attributes.

3. The method as claimed in claim 2, wherein each sequence of the one or more sequences is generated by the processing unit [106] based on:
identifying, by the identification unit [102], one or more past events associated with the one or more current attributes; and
identifying, by the identification unit [102], one or more time-ordered events based on removal of one or more duplicate past events.

4. The method as claimed in claim 1, wherein determining, by the processing unit [106], an occurrence signature for the one or more attributes of each sequence comprises:
assigning, by the processing unit [106], a unique ordinal identifier to a value of the one or more attributes, and
determining, by the processing unit [106], the occurrence signature of the one or more attributes based on the assigned unique ordinal identifier of the value of the one or more attributes.

5. The method as claimed in claim 1, wherein the one or more attributes comprises at least one of one or more numerical attributes and one or more categorical attributes.

6. The method as claimed in claim 1, wherein the one or more positional attributes are determined based on a time stamp associated with the one or more time-ordered events.

7. The method as claimed in claim 1, wherein the one or more time-ordered events are truncated based on one or more predefined rules.

8. The method as claimed in claim 1, wherein each sequence of the one or more time-ordered events is associated with a specific time duration.

9. A system for detecting a fraudulent activity on a digital platform for a current event, the system comprising:
an identification unit [102], configured to identify, an occurrence of the current event on the digital platform;
a transceiver unit [104], configured to receive, one or more sequences based on the occurrence of the current event, wherein each sequence of the one or more sequences comprises of one or more time-ordered events performed on a set of pivots and each sequence of the one or more sequences is associated with a unique event type, wherein each time-ordered event from the one or more time-ordered events comprises one or more attributes;
a processing unit [106], configured to determine, an occurrence signature for one or more attributes of each sequence, wherein the occurrence signature is based on the one or more time-ordered events of a corresponding sequence; and
a sub-system [108], configured to determine, at least one of an interim fraud score and an interim latent representation of each sequence, wherein at least one of the interim fraud score and the interim latent representation of each sequence is based at least on the occurrence signature for the one or more attributes in the corresponding sequence, the one or more attributes in the corresponding sequence, and one or more positional attributes in the corresponding sequence, wherein the processing unit [106] is further configured to:
generate, a fraud score of the current event based at least on: the at least one of the interim fraud score and the interim latent representation of each sequence, and one or more domain specific features associated with the current event, and detect, the fraudulent activity on the digital platform based on the fraud score of the current event.

10. The system as claimed in claim 9, wherein the current event is associated with one or more current attributes.

11. The system as claimed in claim 10, wherein the processing unit [106] is configured to generate each sequence of the one or more sequences based on an identification of:
one or more past events associated with the one or more current attributes, and
one or more time-ordered events based on removal of one or more duplicate past events.

12. The system as claimed in claim 9, wherein to determine an occurrence signature for the one or more attributes of each sequence, the processing unit [106] is configured to:
assign, a unique ordinal identifier to a value of the one or more attributes, and
determine, the occurrence signature of the one or more attributes based on the assigned unique ordinal identifier of the value of the one or more attributes.

13. The system as claimed in claim 9, wherein the one or more attributes comprises at least one of one or more numerical attributes and one or more categorical attributes.

14. The system as claimed in claim 9, wherein the one or more positional attributes are determined based on a time stamp associated with the one or more time-ordered events.

15. The system as claimed in claim 9, wherein the one or more time-ordered events are truncated based on one or more predefined rules.

16. The system as claimed in claim 9, wherein each sequence of the one or more time-ordered events is associated with a specific time duration.
